(19) United States
(12) Patent Application Publication
(10) Pub. No.: US 2014/0362225 A1
(43) Pub. Date: Dec. 11, 2014

(54) Video Tagging for Dynamic Tracking

(71) Applicant: HONEYWELL INTERNATIONAL INC., Morristown, NJ (US)

(72) Inventors: Muthuvel RAMALINGAMOORTHY, Bangalore (IN); Ramesh Molakalolu Subbaiah, Bangalore (IN)

(21) Appl. No.: 13/914,963

(22) Filed: Jun. 11, 2013

(51) Int. Cl. H04N 7/18; G06K 9/00

(52) U.S. Cl. CPC H04N 7/181; G06K 9/00335
USPC 348/159

(57) ABSTRACT

A method and apparatus wherein the method includes the steps of showing a field of view of a camera that protects a secured area of the surveillance system, placing a graphical indicator within the display for detection of an event within the field of view of the camera, detecting the event based upon a moving object within the field of view interacting with the received graphical indicator, receiving a descriptive indicator entered by the surveillance operator adjacent the moving object on the display through the user interface and tracking the moving object through the field of view of another camera and displaying the descriptive indicator adjacent the moving object within the field of view of the other camera on a display of another surveillance operator.

### FIELD

The field of the invention relates to security systems and more particularly to surveillance systems within a security system.

### BACKGROUND

Security systems are generally known. Such systems (e.g., in homes, in factories, etc.) typically include some form of physical barrier and one or more portals (e.g., doors, windows, etc.) for entry and egress by authorized persons. A respective sensor may be provided on each of the doors and windows that detect intruders. In some cases, one or more cameras may also be provided in order to detect intruders within the protected space who have been able to surmount the physical barrier or sensors.

In many cases, the sensors and/or cameras may be connected to a central monitoring station through a local control panel. Within the control panel, control circuitry may monitor the sensors for activation and in response compose an alarm message that is, in turn, sent to the central monitoring station identifying the location of the protected area and providing an identifier of the activated sensor.

In other locations (e.g., airports, municipal buildings, etc.), there may be no or very few physical barriers restricting entry into the protected space and members of the public come and go as they please. In this case, security may be provided by a number of cameras that monitor the protected space for trouble. However, such spaces may require hundreds of cameras monitored by a small number of guards. Accordingly, a need exists for better methods of detecting and tracking events within such spaces.

### BRIEF DESCRIPTION OF THE DRAWINGS

FIG. 1 depicts a system for detecting and tracking events in accordance with an illustrated embodiment;

FIG. 2 depicts a set of steps performed by a surveillance operator in detecting events;

FIG. 3 depicts additional detail of FIG. 2;

FIG. 4 depicts additional detail of FIG. 2;

FIGS. 5A-B depicts different perspectives of the cameras that may be used within the system of FIG. 1;

FIGS. 6A-B depict the tagging of an object in the different view of FIGS. 5A-B;

FIG. 7 depicts tagging in a reception area of a secured area; and

FIG. 8 depicts tagging of FIG. 7 shown in the perspective of other cameras of the system of FIG. 1.

### DETAILED DESCRIPTION OF AN ILLUSTRATED EMBODIMENT

While embodiments can take many different forms, specific embodiments thereof are shown in the drawings and will be described herein in detail with the understanding that the present disclosure is to be considered as an exemplification of the principles hereof, as well as the best mode of practicing same. No limitation to the specific embodiment illustrated is intended.

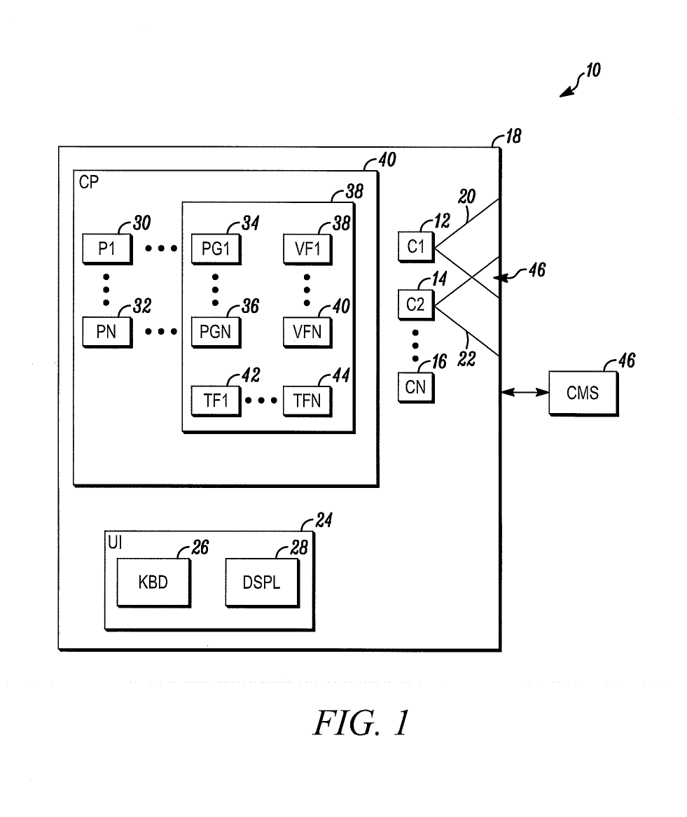

FIG. 1 depicts a security system 10 shown generally in accordance with an illustrated embodiment. Included within the security system may be a number of video cameras 12, 14, 16 that each collect video images within a respective field of view (FOV) 20, 22 within a secured area 18.

Also included within the system is two or more user interfaces (UIs) 24. In this case, each of the user interfaces 24 is used by a respective surveillance operator to monitor the secured area 12 via one or more of the cameras 12, 14, 16. The user interfaces may be coupled to and receive video information from the cameras via a control panel 40.

Included within the control panel is control circuitry that provides at least part of the functionality of the security system. For example, the control panel may include one or more processor apparatus (processors) 30, 32 operating under control of one or more computer programs 34, 36 loaded from a non-transitory computer readable medium (memory) 38. As used herein, reference to a step performed by one of the computer programs is also a reference to the processor that executed that step.

The system of FIG. 1 may include a server side machine (server) and a number (e.g., at least two) client side machines (e.g., an operator console or terminal). Each of the server side machine and client side machines include respective processors and programs that accomplish the functionality described herein. The client side machines each interact with a respective human surveillance operator via the user interface incorporated into an operator console. The server side machine handles common functions such as communication between operators (via the server and respective client side machines) and saving of video into respective video files 38, 40.

Included on each of the user interfaces is a display 28. The display 28 may be an interactive display or the user interface may have a separate keyboard 26 through which a user may enter data or make selections.

For example, the user may enter an identifier to select one or more of the cameras 12, 14, 16. In response, video frames from the selected camera(s) are shown on the display 28.

Also included within each of the user interfaces may be a microphone 48. The microphone may be coupled to and used to deliver an audio message to a respective speaker 50 located within a field of view of one or more of the cameras. Alternatively, the operator may pre-record a message that is automatically delivered to the associated speaker whenever a person/visitor triggers an event associated with the field of view.

Included within the control panel may be one or more interface processors of the operator console that monitor the user interface for instructions from the surveillance operator. Inputs may be provided via the keyboard 26 or by selection of an appropriate icon shown on the display 28. For example, the interface processor may show an icon for each of the cameras along one side of the screen of the display. The surveillance operator may select any number of icons and, in response, a display processor may open a separate window for each camera and simultaneously show video from each selected camera on the respective display. Where a single camera is selected, the window showing video from that camera may occupy substantially the entire screen. When more than one camera is selected, a display processor may adjust the size of the respective windows and the scale of the video image in order to simultaneously show the video from many cameras side-by-side on the screen.

In general, current closed circuit television (CCTV) systems don't provide operators with tools that can be adapted by the individual operator to that operator's monitoring environment. In contrast, the system described herein allows operators to create their own client side rules. For example, current CCTV systems do not allow the operator to interact with the environment through that operator's monitor. As there is no interaction between the operator and monitor, an operator monitoring more than about ten cameras at the same time may not be able to adequately monitor all of the cameras simultaneously. Hence, there is a high risk that some critical events that should cause alarm may be missed.

Another failing of current CCTV systems is that there is no mechanism that facilitates easy communication between operators in order to quickly track an object or person. For instance, if a CCTV operator wants to track a person with the help of other operators, then he/she must first send a screen shot/video clip to the other operator and then call/ping the other operator to inform the other operator of the subject matter and reason for the tracking. For a new or inexperienced operator, it is very difficult to quickly understand the need for tracking in any particular case and to be able to quickly execute on that need. Hence, there is a high risk of missed signals/miscommunication among operators.

The system of FIG. 1 operates by providing an option for operators to create user side rules by interacting with their live video in order to create trigger points using a touch screen or a cursor controlled via a mouse or keyboard. This allows an operator to quickly create his/her own customized rules and to receive alerts. This is different than the server side rules of the prior art because it allows an operator to quickly react to the exigencies appearing in the respective windows of the operator's monitor. This allows an operator monitoring many cameras to configure his/her own customized rules for each view/camera so that they are notified/alerted based upon the configured rules for that view/camera. This reduces the burden on the operator to actively monitor all of the cameras at the same time.

For example, assume that the operator is monitoring a public space through a number of video feeds from respective cameras and a situation arises that compromises the security of that space. For example, an airport has a secured area where only people who have gone through security are allowed and a non-secured space. Assume now that an alarmed access door must be opened to allow maintenance people to flow between the secured and non-secured space. In this case, the area must be closely monitored to ensure that there is no interaction between the maintenance people in the maintenance area and other people in the secured area. In this case, the operator can quickly create a rule by placing a graphic indicator (e.g., drawing a perimeter on the image) around the maintenance subarea of the secured space. In this example, the placing of the graphic indicator around the maintenance area creates a rule that causes the operator to receive an alert whenever anyone crosses that line or border. Processing of this rule happens on the client machine (operator's console) only and only that client (i.e., human surveillance operator) receives an alert. In this case, client side analytics of that operator's machine evaluates the actions that take place in that video window.

If someone does cross that line or border, then the client side analytics alerts the operator via a pop-up. If the operator does not respond within a predetermined time period, the client side analytics will notify a supervisor of the operator.

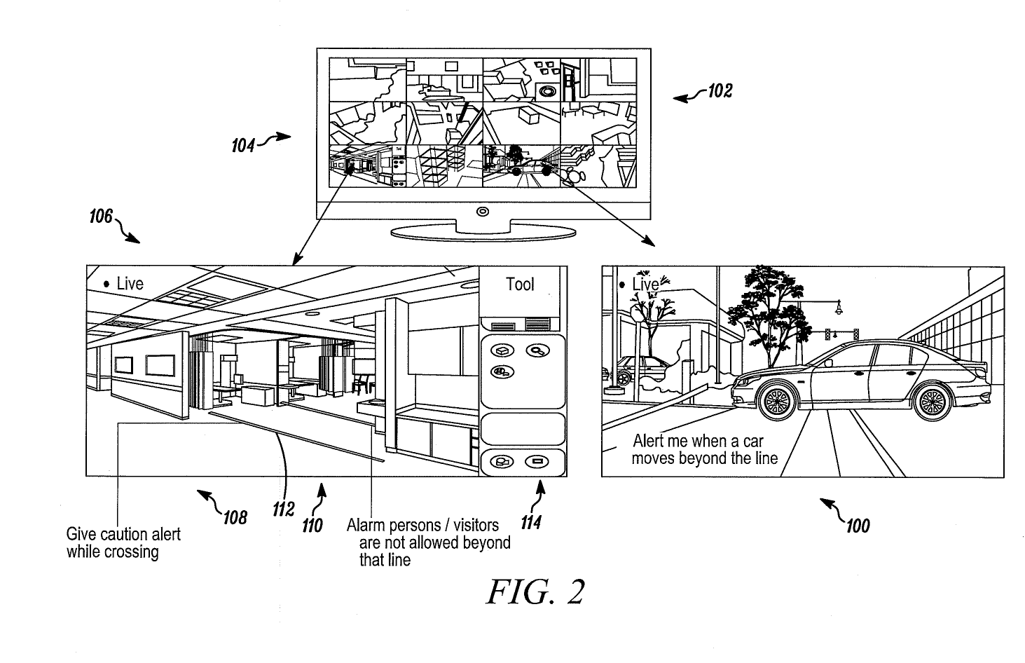

This example may be explained in more detail as follows. For example, FIG. 2 depicts a set of steps that may be performed by a surveillance operator. In this case, the operator may be viewing a display 102 with a number of windows, each depicting live video from a respective camera. In this case, the operator may be notified that maintenance must be performed in the area shown within the window 104 and located in the lower-left corner of the screen. In this case, the operator selects (clicks) on the window or first activates a rule processor icon and then the window.

In response, the rule entry window 106 appears on the display. Returning to the example above, the operator may determine that the window 106 has a secured area 108 and a non-secure area 110. In order to create a rule, the operator places the graphic indicator (i.e. a line, a rectangle, circle, etc.) 112 within the window between two geographic features (barriers) that separate the secure area from the non-secure area. The line may be created by the operator selecting the proper tool from a tool area 114, drawing the line using his finger on the interactive screen or by first placing a cursor on one end, clicking on the location, moving to the other end of the line and clicking on the second location. In this case, a graphics processor may detect the location of the line via the operator's actions and draw the line 112, as shown. The location of the line may be forwarded to a first rule processor that subsequently monitors for activity proximate the created line.

Separately, a tracking processor (either within the server side machine or client side machines) processes video frames from each camera in order to detect a human presence within each video stream. The tracking processor may do this by comparing successive frames in order to detect changes. Pixel changes may be compared with threshold values for the magnitude of change as well as the size of a moving object (e.g., number of pixels involved) to detect the shape and size of each person that is located within a video stream.

As each human is detected, the tracking processor may create a tracking file 42, 44 for that person. The tracking file may contain a current location as well as a locus of positions of past locations and a time at each position.

It should be noted in this regard that the same person may appear in different locations of the field of view of each different camera. Recognizing this, the tracking processor may correlate different appearances of the same person by matching the images characteristics around each tracked person with the image characteristics around each other tracked person (accounting for the differences in perspective). This allows for continuity of tracking in the event that a tracked person passes completely out of the field of view of a first camera and enters the field of view of a second camera.

The appearances of the same person in different locations of different cameras may be accommodated by the creation of separate files with the appropriate cross-reference. Alternatively, each person may be tracked within a single file with a separate coordinate of location provided for the field of view of each camera.

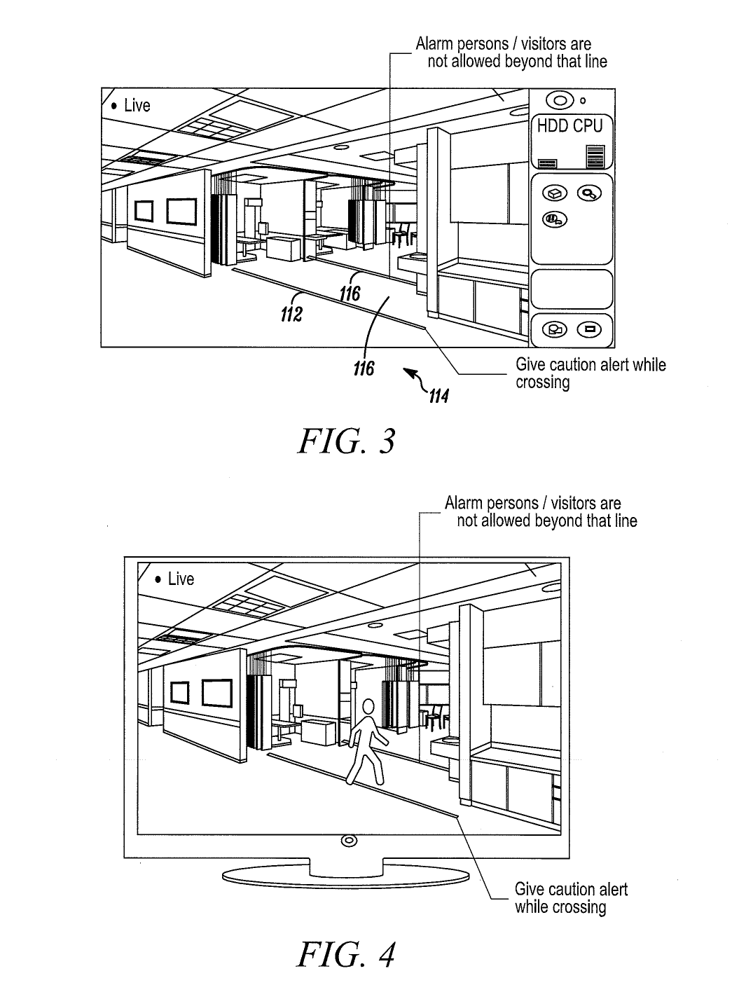

Returning now to the creation of rules, FIG. 3 provides an enlarged, more detailed view of the screen 106 of FIG. 2. As may be noted from FIG. 3, the creation of the line 112 (and rule) may also cause the rule processor to confirm creation of the rule by giving an indication 114 of the action that is to be taken upon detecting a person crossing the line. In this case, the indication given is to display the alert “Give Caution alert while crossing” to the surveillance operator that created the rule.

As an alternative or in addition to creating a single graphical indicator for generating an alert, the operator may create a graphical indicator that has a progressive response to intrusion. In the example shown in FIG. 3, the graphical indicator may also include a pair of parallel lines 112, 116 that each evoke a different response as shown by the indicators 114, 116 in FIG. 3.

As shown in FIG. 3, the first line 112 may provoke the response “Give Caution alert while crossing” to the operator. However, the second line 116 may provoke the second response of “Alarm, persons/visitors are not allowed beyond that line” and may not only alert the operator, but also send an alarm message to a central monitoring station 46. The central monitoring station may be a private security or local police force that provides a physical response to incursions.

In addition, the operator may also deliver an audible message to the person/visitor that the operator observes entering a restricted area. In this case, the operator may activate the microphone on the user interface and annunciate a message through the speaker in the field of view of the cameras to deliver a warning to the person/visitor that he/she is entering a restricted area and to return to the non-restricted area immediately. Alternatively, the operator can pre-record a warning message that will be delivered automatically when the person/visitor crosses the line.

Once a rule has been created for a particular camera (and display window), a corresponding rule processor retrieves tracking information from the tracking processor regarding persons in the field of view of that camera. In this case, the rule processor compares a location of each person within a field of view of the camera with the locus of points that defines the graphical indicator in order to detect the person interacting with the line. Whenever there is a coincidence between the location of the person and graphical indicator (e.g., see FIG. 4), the appropriate response is provided by the rule processor to the human operator. The response may be a pop-up on the screen of the operator indicating the camera involved. Alternatively, the rule processor may enlarge the associated window in order to subsume the entire screen as shown in FIG. 4 thereby clearly showing the intruder crossing the graphical indicator and providing the indicator 114, 116 of what rule was violated.

In another embodiment, the system allows the client side machine and surveillance operator to tag a person of interest for any reason. In the example above, the surveillance operator may detect a maintenance worker moving across the lines 112, 116 from the maintenance subarea into the secured area of an airport via receipt of an alert (as discussed above). In this case, the operator may wish to tag the maintenance worker so that other operators may also track the worker as the worker enters the field of view of other cameras. Alternatively, the operator may observe a visitor to an airport carrying a suspicious object (e.g., an unusual suitcase).

In such situation, the operator may wish to track the suspicious person/object and may want to inform/alert other operators. In this case, the system allows the operator to quickly draw/write appropriate information over the video that is made available to all other operators who see that person/object.

In this case, the tagging of objects/persons is based upon the ability of the system to identify objects that appear on the video (server side analytics algorithms) and is able to track those objects in various cameras. In this case, detection may be based upon the assumption that the object is initially being carried by a human and is separately detectable (and trackable) based upon the initial association with that human. In this case, if the person deposits that object on a luggage conveyor, that object may be separately tracked based upon its movement and its original association with the tracked human.

For example, a surveillance operator at an airport may notice a person carrying a suspicious suitcase. While the operator is looking at the person/suitcase, the operator can attach a description indicator to the suitcase. The operator can do this by first drawing a circle around the suitcase and then writing a descriptive term on the screen adjacent to or over the object. The system is then able to map the location of the object into the other camera views. This then allows the message to be visible to other operators viewing the same object at different angles.

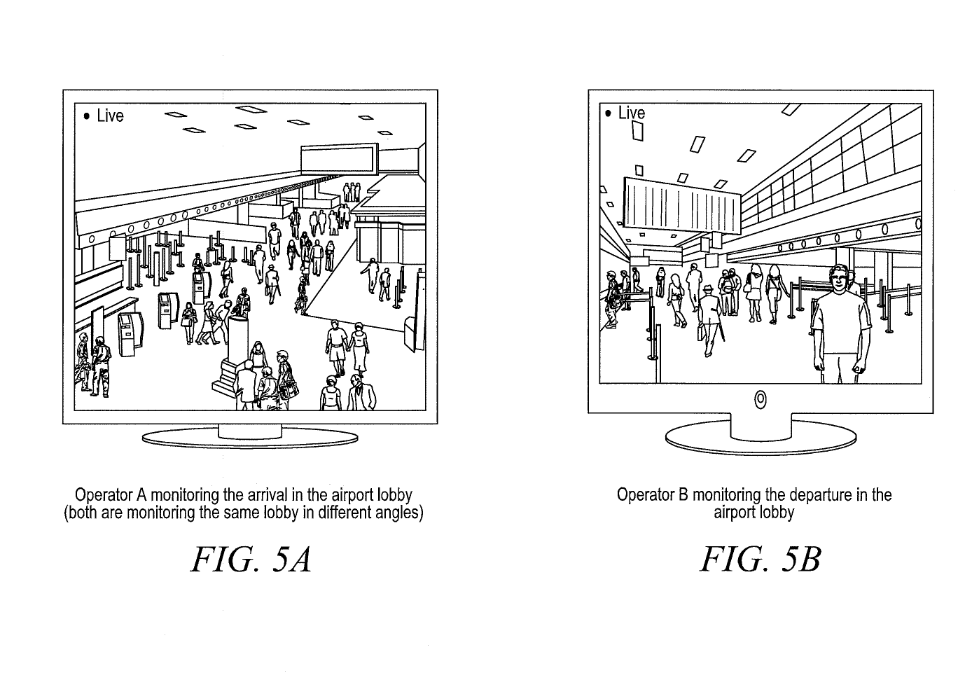

As a more specific example, FIGS. 5A and B depict the displays on the user interfaces (displays) of two different surveillance operators. In this regard, FIG. 5A shows the arrival area of an airport and FIG. 5B shows a departure area. It should be noted in this regard that significant overlap 46 exists between the field of view of the first camera of FIG. 5A and the field of view of the second camera of FIG. 5B.

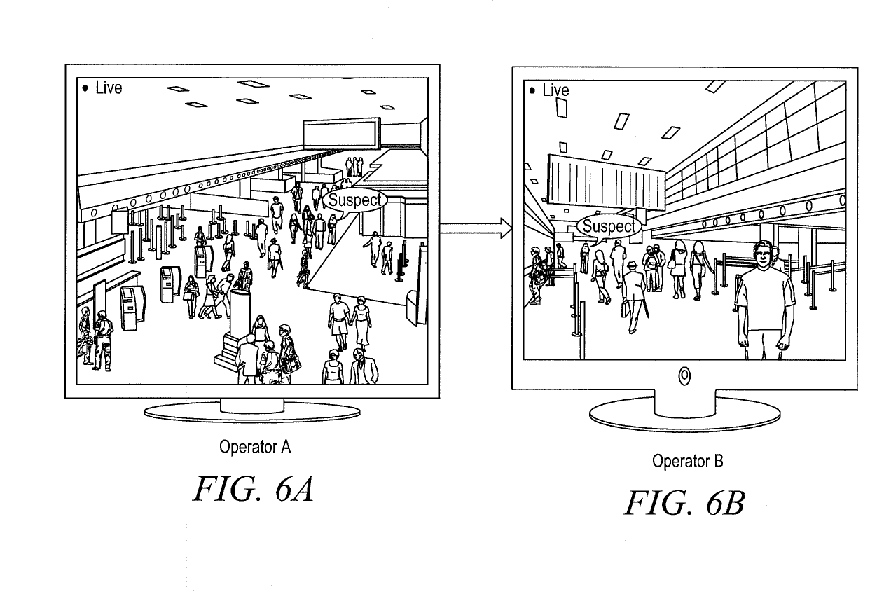

In order to tag an object/person, the operator activates a tagging icon on his display to activate a tagging processor. Next, the operator draws a circle around the object/person and writes a descriptive indicator over or adjacent the circle as shown in FIG. 6A.

Alternatively, the operator places a cursor over the object/person and activates a switch on a mouse associated with the cursor. The operator may then type in the descriptive indicator.

The tagging processor receives the location of the tag and descriptive indicator and associates the location of the tag with the location of the tracked object/person. It should be noted in this regard that the coordinates of the tag are the coordinates of the field of view in which the tagging was first performed.

The tagging processor also sends a tagging message to the tracking processor of the server. In response, the tracking processor may add a tagging indicator to the respective file 42, 44 of the tracked person/object. The tracking processor may also correlate or otherwise map the location of the tagged person/object from the field of view in which the person/object was first tagged to the locations in the fields of views of the other cameras.

In addition, the tracking processor sends a tagging instruction to each operator console identifying the tracked location of the person/object and the descriptive indicator associated with the tag. The tracking processor may send a separate set of coordinates that accommodates the field of view of each camera. In response, a respective tagging processor of each respective operator console imposes the circle and descriptive indicator over the tagged person/object in the field of view of each camera on the operators console as shown in FIG. 6B.

Similarly, the operator of a first console may tag a person for tracking in the other fields of view of the other cameras. In this case, the tagging of a person occurs substantially the same as the tracking of an object, as discussed above. The tag is retained by the system and appears on the display of each surveillance operator in the respective windows displayed on the console of the operator.

As another example, assume that a surveillance operator is monitoring the reception area (e.g., lobby of a building) of a restricted area and may wish to tag each visitor before they enter a secured area (e.g., the rest of the building, a campus, etc.). In this case, tagging of visitors as they enter through a reception area allows visitors to be readily identified as they move through the remainder of the secured area and as they pass through the fields of view of other cameras.

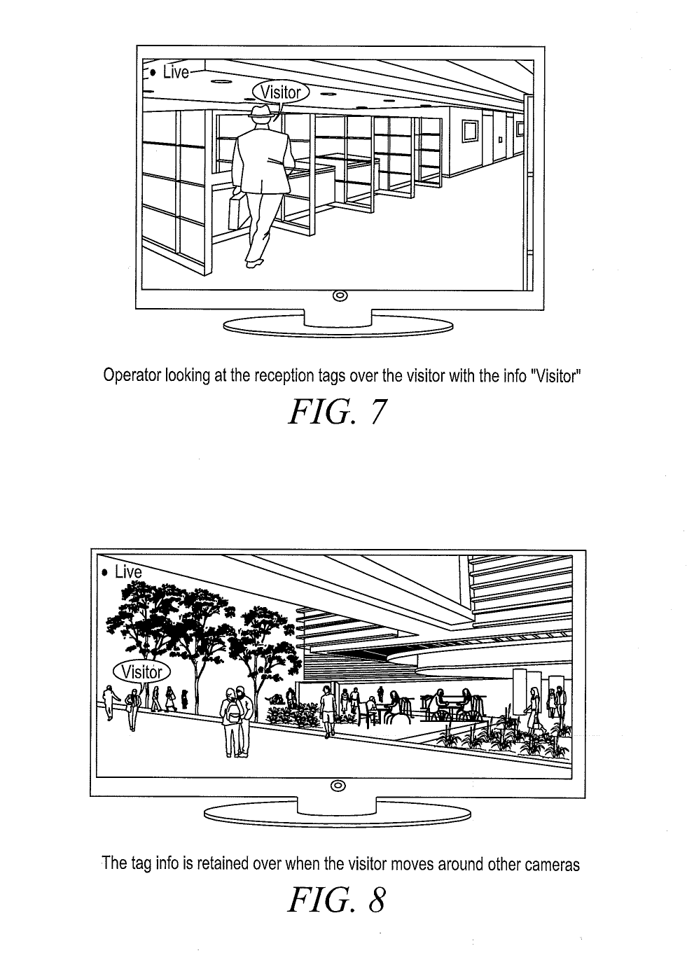

For example, FIG. 7 shows a tag attached by the operator as the visitor enters through a reception area. FIG. 8 shows the tag shown attached to the visitor traveling through the field of view of another camera.

In general, the system provides the steps of showing a field of view of a camera that protects a secured area of the surveillance system, placing a graphical indicator within the display for detection of an event within the field of view of the camera, detecting the event based upon a moving object within the field of view interacting with the received graphical indicator, receiving a descriptive indicator entered by the surveillance operator adjacent the moving object on the display through the user interface and tracking the moving object through the field of view of another camera and displaying the descriptive indicator adjacent the moving object within the field of view of the other camera on a display of another surveillance operator.

In another embodiment, the system includes an event processor of a surveillance system that detects an event within the field of view of a camera of the surveillance system based upon movement of a person or object within a secured area of the surveillance system, a processor of the surveillance system that receives a descriptive indicator entered by a surveillance operator adjacent the moving object on a display through a user interface of the display and a processor of the surveillance system that tracks the moving object through the field of view of another camera and displaying the descriptive indicator adjacent the moving object within the field of view of the other camera on a display of another surveillance operator.

The system may also include a processor of the surveillance system that detects the operator of the user interface placing a graphical indicator within the display for detection of the event within the field of view of a first camera. The system may also include a processor that detects the event based upon interaction of the moving person or object with the placed graphical indicator.

From the foregoing, it will be observed that numerous variations and modifications may be effected without departing from the spirit and scope hereof. It is to be understood that no limitation with respect to the specific apparatus illustrated herein is intended or should be inferred. It is, of course, intended to cover by the appended claims all such modifications as fall within the scope of the claims.

1. A method comprising:
a user interface of a surveillance system showing a field of view of a camera that protects a secured area of the surveillance system, the field of view is shown of a display of the user interface;
the surveillance system detecting an operator of the user interface placing a graphical indicator within the display for detection of an event within the field of view of the camera;
the surveillance system detecting the event based upon a moving object within the field of view interacting with the received graphical indicator;
the surveillance system receiving a descriptive indicator entered by the surveillance operator adjacent the moving object on the display through the user interface; and
the surveillance system tracking the moving object through the field of view of another camera and displaying the descriptive indicator adjacent the moving object within the field of view of the other camera on a display of another surveillance operator.

2. The method as in claim 1 wherein the graphical indicator further comprises a line drawn by the operator between two physical locations of the secured area.

3. The method as in claim 1 wherein the graphical indicator further comprises a rectangle drawn by the operator around a subarea of the secured area.

4. The method as in claim 1 further comprising the surveillance operator drawing the graphical indicator on an interactive screen.

5. The method as in claim 1 wherein the descriptive indicator further comprises the word “visitor.”

6. The method as in claim 1 further comprising the surveillance operator detecting suspicious activity within a subarea of the secured area and drawing a rectangle around the subarea as the graphical indicator.

7. The method as in claim 6 wherein the descriptive indicator further comprises a type of suspicious activity detected within the subarea.

8. The method as in claim 1 wherein the graphical indicator further comprises a pair of parallel lines that separate a subarea of suspicious activity from a subarea of non-suspicious activity within the secured area.

9. The method as in claim 8 further comprising generating an alert to the surveillance operator upon detecting the moving object crossing a first of the pair of parallel lines.

10. The method as in claim 8 further comprising the operator delivering an audible warning message to the subarea of suspicious activity or a processor automatically delivering a pre-recorded audible warning message upon detecting the event.

11. The method as in claim 9 further comprising generating an alarm upon detecting the moving object crossing the second of the pair of parallel lines.

12. An apparatus comprising:
an event processor of a surveillance system that detects an event within the field of view of a camera of the surveillance system based upon movement of a person or object within a secured area of the surveillance system;
a processor of the surveillance system that receives a descriptive indicator entered by a surveillance operator adjacent the moving object on a display through a user interface of the display; and
a processor of the surveillance system that tracks the moving object through the field of view of another camera and displaying the descriptive indicator adjacent the moving object within the field of view of the other camera on a display of another surveillance operator.

13. The apparatus as in claim 12 further comprising a processor of the surveillance system that detects the operator of the user interface placing a graphical indicator within the display for detection of the event within the field of view of a first camera.

14. The apparatus as in claim 13 further comprising a processor that detects the event based upon interaction of the moving person or object with the placed graphical indicator.

15. The apparatus as in claim 12 further comprising a microphone coupled to a speaker within the field of view of the camera that allows the operator to deliver a warning audible message to an intruder based upon the detected event.

16. The apparatus as in claim 13 wherein the graphical indicator further comprises a line drawn by the operator between two physical locations of the secured area.

17. The apparatus as in claim 12 wherein the descriptive indicator further comprises the word “visitor” or another word indicating a type of suspicious activity detected within the subarea.

18. The apparatus as in claim 12 wherein the graphical indicator further comprises a pair of parallel lines that separate a subarea of suspicious activity from a subarea of non-suspicious activity within the secured area.

19. The apparatus as in claim 18 further comprising a processor that generates an alert to the surveillance operator upon detecting the moving object crossing a first of the pair of parallel lines and an alarm upon detecting the moving object crossing the second of the pair of parallel lines.

20. An apparatus comprising:
a user interface of a surveillance system that shows a field of view of a camera that protects a secured area of the surveillance system, the field of view is shown of a display of the user interface;
a processor of the surveillance system that detects an operator of the user interface placing a graphical indicator within the display for detection of an event within the field of view of a first camera;
a processor of the surveillance system that detects the event based upon a moving object within the field of view interacting with the received graphical indicator;
a processor of the surveillance system that receives a descriptive indicator entered by the surveillance operator adjacent the moving object on the display through the user interface; and
a processor of the surveillance system that tracks the moving object through the field of view of another camera and displays the descriptive indicator adjacent the moving object within the field of view of the other camera on a display of another surveillance operator.
